(19) United States
(12) Patent Application Publication
(10) Pub. No.: US 2024/0412904 A1
(43) Pub. Date: Dec. 12, 2024

(54) METHOD FOR MANUFACTURING Mn-Bi BASED SINTERED MAGNET, AND Mn-Bi BASED SINTERED MAGNET MANUFACTURED THEREFROM

(71) Applicant: KOREA INSTITUTE OF MATERIALS SCIENCE, Changwon-si, Gyeongsangnam-do (KR)

(72) Inventors: Chul Jin CHOI, Changwon-si, Gyeongsangnam-do (KR); Jong Woo KIM, Changwon-si, Gyeongsangnam-do (KR); Ji Hoon PARK, Changwon-si, Gyeongsangnam-do (KR); Nam Kyu KIM, Changwon-si, Gyeongsangnam-do (KR); Han kuk JEON, Sacheon-si, Gyeongsangnam-do (KR)

(21) Appl. No.: 18/700,907

(22) PCT Filed: Jul. 15, 2022
(86) PCT No.: PCT/KR2022/010388

§ 371 Date: Apr. 12, 2024

(30) Foreign Application Priority Data
Oct. 13, 2021 (KR) 10-2021-0135868

(51) Int. Cl. H01F 1/08; B22F 3/14; B22F 9/04; H01F 41/02

(52) U.S. Cl. CPC H01F 1/086; B22F 3/14; H01F 41/0266; B22F 2009/043; B22F 2301/40; B22F 2304/10; B22F 2998/10

(57) ABSTRACT

The present disclosure provides a method for manufacturing a Mn—Bi based sintered magnet with a simple process and a Mn—Bi based sintered magnet having excellent magnetic properties such as maximum magnetic energy product manufactured therefrom.

### TECHNICAL FIELD

This specification claims priority to and the benefit of Korean Patent Application No. 10-2021-0135868 filed in the Korea Intellectual Property Office on Oct. 13, 2021, and the entire contents thereof are included in the present disclosure.

The present disclosure relates to a method for manufacturing a Mn—Bi based sintered magnet and the Mn—Bi based sintered magnet manufactured therefrom. Specifically, it relates to a method for manufacturing a Mn—Bi based sintered magnet with excellent magnetic properties and the Mn—Bi based sintered magnet manufactured therefrom.

### BACKGROUND ART

Due to the depletion of fossil fuels and environmental pollution problems, interest in green energy to solve these problems is increasing. Accordingly, the demand for high-performance permanent magnets used in eco-friendly wind power generators, electric and hybrid vehicles, etc. is rapidly increasing.

Permanent magnets are applied in a wide range of fields, including electronic device, information and communication, medical, and machine tool fields, and industrial automobile motors. In particular, expectations for the development of permanent magnets with excellent characteristics are increasing due to the increase in the spread of electric vehicles and the demand for energy saving and improved power generation efficiency in the industrial fields.

However, rare earth elements, which are currently widely used in the permanent magnet field, are entirely dependent on imports, and as countries with rare earth resources are turning rare earth elements into strategic materials, the issue of price and supply instability is becoming a major issue. In addition, the use of rare earth permanent magnets is limited in high temperature applications such as the hybrid and electric vehicle motors due to the rapid magnetic properties decreases in high temperature regimes.

Therefore, the research on permanent magnets with high coercivity in high temperature applications without using rare earth elements has been actively conducted recently, mainly in the United States, China, and Japan. Since Mn-based permanent magnets among non-rare earth permanent magnets, especially Mn—Bi based permanent magnets, have a theoretical maximum energy product reaching to 18 MGOe and have magnetic properties of increasing coercivity as the temperature rises, they are a strong candidate to replace existing permanent magnets in high temperature applications.

However, in manufacturing such Mn—Bi based permanent magnets, there is a problem that the performance of the Mn—Bi based master alloy deteriorates with more and longer processing processes. Accordingly, it is necessary to provide a Mn—Bi based permanent magnet with excellent magnetic properties, especially at high temperatures, in a simpler method.

### DISCLOSURE

### Technical Problem

The technical problem to be achieved by the present disclosure is to provide a method for manufacturing a Mn—Bi based sintered magnet with a simple process and a Mn—Bi based sintered magnet having excellent magnetic properties such as a maximum magnetic energy product manufactured therefrom.

However, the problem to be solved by the present disclosure is not limited to the problems mentioned above, and other problems not mentioned will be clearly understood by those skilled in the art from the following description.

### Technical Solution

According to one aspect of the present disclosure, there is provided a method for manufacturing a Mn—Bi based sintered magnet, including steps of: preparing a Mn—Bi based magnetic phase powder; and hot-pressing the magnetic phase powder under a magnetic field to manufacture it into a bulk magnet, wherein the magnetic phase powder has a particle size distribution that satisfies the following Equation 1:

$$2.5 μm \leq D 50 \leq 4. μm \qquad [ Equation 1 ]$$

D50 is an average diameter (μm) of the point where the volume cumulative distribution of the diameter of the magnetic phase powder is 50%.

According to the other aspect of the present disclosure, there is provided a Mn—Bi based sintered magnet which is manufactured by the method and has a maximum magnetic energy product ((BH)ₘₐₓ) of 6 MGOe or more.

### Advantageous Effects

The method for manufacturing a Mn—Bi based sintered magnet according to one embodiment of the present disclosure can provide a magnet with excellent magnetic properties such as a maximum magnetic energy product.

The method for manufacturing a Mn—Bi based sintered magnet according to one embodiment of the present disclosure can reduce performance degradation of the Mn—Bi based sintered magnet by simplifying the process by performing hot pressing under a magnetic field in-situ and manufacturing the magnet.

The method for manufacturing a Mn—Bi based sintered magnet according to one embodiment of the present disclosure can provide a well-oriented Mn—Bi based sintered magnet even in a relatively low magnetic field.

The Mn—Bi based sintered magnet according to one embodiment of the present disclosure can have excellent magnetic properties by having a large maximum magnetic energy product.

The effects of the present disclosure are not limited to the effects described above, and effects not mentioned will be clearly understood by those skilled in the art from this specification.

### BRIEF DESCRIPTION OF DRAWINGS

FIG. 1a is a particle size distribution graph of the Mn—Bi based magnetic phase powders prepared in Preparation Examples 2 to 8.

FIG. 1b is a graph showing D90 of the Mn—Bi based magnetic phase powders prepared in Preparation Examples 2 to 8.

FIG. 1c is a graph showing D50 of the Mn—Bi based magnetic phase powders prepared in Preparation Examples 2 to 8.

FIG. 1d is a graph showing D10 of the Mn—Bi based magnetic phase powders prepared in Preparation Examples 2 to 8.

FIG. 2 is a graph comparing maximum magnetic energy product fractions according to powder ball milling time of the Mn—Bi based sintered magnets manufactured in Examples 1 to 4 and Comparative Examples 2 to 5.

FIG. 3 is a graph comparing maximum magnetic energy product fractions according to the pressure raising time of the Mn—Bi based sintered magnets manufactured in Examples 4 to 7.

FIG. 4 is a graph comparing densities and maximum magnetic energy product fractions according to the final temperature of the Mn—Bi based sintered magnets manufactured in Example 4 and Examples 12 to 15.

### BEST MODE

In this specification, when a part “includes” a certain component, this means that the part may further include other components rather than excluding other components, unless specifically stated to the contrary.

Throughout this specification, when a member is said to be located “on” another member, this includes not only the case where the member is in contact with the other member, but also the case where another member exists between the two members.

Hereinafter, the present disclosure will be described in more detail.

According to one aspect of the present disclosure, there is provided a method for manufacturing a Mn—Bi based sintered magnet, including steps of: preparing a Mn—Bi based magnetic phase powder; and hot-pressing the magnetic phase powder under a magnetic field to manufacture it into a bulk magnet, wherein the magnetic phase powder has a particle size distribution that satisfies the following Equation 1:

$$2.5 μm \leq D 50 \leq 4. μm \qquad [ Equation 1 ]$$

D50 is an average diameter (μm) of the point where the volume cumulative distribution of the diameter of the magnetic phase powder is 50%.

The method for manufacturing a Mn—Bi based sintered magnet according to one embodiment of the present disclosure can provide a magnet with excellent magnetic properties such as maximum magnetic energy product, can reduce performance degradation of the Mn—Bi based sintered magnet by simplifying the process by performing hot pressing under a magnetic field in-situ and manufacturing the magnet, and can provide a well-oriented Mn—Bi based sintered magnet even in a relatively low magnetic field by using powder with an appropriate particle size as the raw material for the magnet.

Hereinafter, the respective steps will be described in detail in order.

According to one embodiment of the present disclosure, first, a Mn—Bi based magnetic phase powder whose particle size distribution satisfies Equation 1 below is prepared.

$$2.5 μm \leq D 50 \leq 4. μm \qquad [ Equation 1 ]$$

D50 is an average diameter (μm) of the point where the volume cumulative distribution of the diameters of the magnetic phase powder is 50%.

That is, D50 may be 2.5 μm to 4.0 μm, specifically 2.75 μm to 4.0 μm, or 2.9 μm to 3.5 μm.

According to one embodiment of the present disclosure, the Mn—Bi based magnetic phase powder may satisfy Equation 2 below.

$$5. μm \leq D 90 \leq 10. μm \qquad [ Equation 2 ]$$

D90 is an average diameter (μm) of the point where the volume cumulative distribution of the diameters of the magnetic phase powder is 90%.

That is, D90 may be 5.0 μm to 10.0 μm, specifically 5.2 μm to 8.0 μm, or 5.7 μm to 6.5 μm.

According to one embodiment of the present disclosure, the Mn—Bi based magnetic phase powder may satisfy Equation 3 below.

$$1.1 μm \leq D 10 \leq 1.5 μm \qquad [ Equation 3 ]$$

D10 is an average diameter (μm) of the point where the volume cumulative distribution of the diameters of the magnetic phase powder is 10%.

That is, D10 may be 1.1 μm to 1.5 μm, specifically 1.15 μm to 1.35 μm, or 1.17 μm to 1.24 μm.

Since the powder has an appropriate size by using the Mn—Bi based magnetic phase powder having the above particle size distribution, the magnetic properties of the Mn—Bi powder can be maintained without any significant deterioration while enabling the powder to be well oriented even in a low magnetic field.

According to one embodiment of the present disclosure, the method for manufacturing a Mn—Bi based magnetic phase powder itself is not limited, and the Mn—Bi based magnetic phase powder may be manufactured by, for example, the following method.

According to one embodiment of the present disclosure, the step of preparing a Mn—Bi based magnetic phase powder may include steps of: manufacturing a Mn—Bi based magnetic phase alloy; pulverizing the Mn—Bi based magnetic phase alloy to prepare a Mn—Bi based magnetic phase coarse powder; and micronizing the Mn—Bi based magnetic phase coarse powder to prepare a Mn—Bi based magnetic phase powder.

According to one embodiment of the present disclosure, the Mn—Bi based magnetic phase alloy may be manufactured first. Specifically, a raw material containing a Mn-based material and a Bi-based material may be melted by an induction heating melting method to prepare a mixed melt, the mixed melt may be rapidly solidified to manufacture a Mn—Bi based master alloy (ingot), and then the Mn—Bi based master alloy may be annealed to manufacture a Mn—Bi based magnetic phase alloy.

According to one embodiment of the present disclosure, when preparing the mixed melt, the melting may be performed at a temperature of 545K to 1500K. The melting may be performed by one or more methods selected from an induction heating process, an arc-melting process, a mechanochemical process, and a sintering process.

According to one embodiment of the present disclosure, the raw material may be a powder phase, and specifically, the Mn-based material and Bi-based material may be a Mn metal powder and a Bi metal powder, and the raw material may contain inevitable impurities in addition to the Mn-based material and Bi-based material. That is, the raw material may be prepared by mixing a Mn metal powder and a Bi metal powder.

According to one embodiment of the present disclosure, the raw material may further contain other materials in addition to the Mn-based material and Bi-based material. Specifically, the raw material may contain one or more of other metallic elements and/or non-metallic elements such as Sn, Mg, and Sb in addition to the Mn-based material and Bi-based material. The Mn—Bi based magnetic phase alloy has a composition of MnₓBi_{1-x-y}A_{y}, where A may be one or more selected from Sn, Mg, Sb, C, and N, x may be 0.4 to 0.6, and y may be 0 to 0.1. The composition of the magnetic phase alloy may be adjusted by preparing the raw material to satisfy the composition based on the atomic ratio of Mn, Bi, Sn, Mg, and Sb, and specifically, it may be adjusted by preparing the raw material by mixing metal and non-metal powders of Mn, Bi, Sn, Mg, and Sb in consideration of the atomic ratio of Mn, Bi, Sn, Mg, and Sb to satisfy the composition. In addition, the types and addition amounts of such metallic elements and non-metallic elements may be adjusted depending on the purpose of the sintered magnet manufactured.

According to one embodiment of the present disclosure, in manufacturing a Mn—Bi based magnetic phase alloy by annealing the mixed melt, the annealing may be performed at a temperature of 400K or higher to 700K or lower for 24 hours or more to 96 hours or less in an inert atmosphere, for example, Ar atmosphere. For example, the annealing may be performed at a temperature of 500K or higher to 600K or lower for 48 hours or more to 84 hours or less, specifically, at a temperature of 573K for 72 hours. The Mn—Bi based magnetic phase alloy may be obtained through the annealing.

According to one embodiment of the present disclosure, the Mn—Bi based magnetic phase alloy may have a composition of MnₓBi₁₋ₓ, wherein x may be 0.4 to 0.6 or 0.55 to 0.56. The composition of the magnetic phase alloy may be adjusted by preparing a raw material to satisfy the composition based on the atomic ratio of Mn and Bi, and specifically, it may be adjusted by preparing the raw material by mixing a Mn metal powder and a Bi metal powder in consideration of the atomic ratio of Mn and Bi to satisfy the composition.

According to one embodiment of the present disclosure, after that, a Mn—Bi based magnetic phase coarse powder may be prepared by pulverizing the Mn—Bi based magnetic phase alloy. “Coarse powder” may mean a powder with large and coarse particles. This may be a step of pulverizing the alloy as an intermediate step before micronizing the Mn—Bi based magnetic phase alloy.

The pulverizing may be performed using a general pulverizing method in the relevant technical field. For example, a coarse powder of less than a certain size, for example, a particle diameter of about 25 μm to 150 μm, may be obtained by performing crushing and sieving.

According to one embodiment of the present disclosure, a Mn—Bi based magnetic phase powder may be prepared by micronizing the Mn—Bi based magnetic phase coarse powder. For example, the Mn—Bi based magnetic phase powder may have a particle diameter of 2.5 μm to 4 μm in the case of D50.

That is, a coarse powder with a particle diameter of about 25 μm to 150 μm may be micronized by ball milling to prepare a Mn—Bi based magnetic phase powder that satisfies the above particle size distribution.

According to one embodiment of the present disclosure, the step of micronizing the coarse powder may be performed by ball milling the Mn—Bi based magnetic phase coarse powder for 3 to 21 hours. The ball milling time may be 3 hours to 21 hours, 6 hours to 21 hours, 6 hours to 15 hours, or 9 hours to 12 hours. When ball milling is performed within the above time range, a Mn—Bi based sintered magnet with excellent magnetic properties may be manufactured by providing a powder having an appropriate size by satisfying the particle size distribution.

According to one embodiment of the present disclosure, the ball milling may be low-energy ball milling, may be performed under conditions of 100 rpm to 300 rpm, and the balls may be Φ3 to Φ7. In addition, ball milling may be performed by introducing the balls so that the weight ratio of the Mn—Bi based magnetic phase coarse powder to the balls is about 10:1.

According to one embodiment of the present disclosure, the Mn—Bi based magnetic phase powder prepared as above is manufactured into a bulk magnet by performing hot pressing under a magnetic field. In the case of Mn—Bi based magnetic phase powder, it is very sensitive to the surrounding environment and easily deteriorates, so there are characteristics that care should be taken when handling it. Furthermore, its magnetic properties tend to deteriorate significantly even in the step of processing it, so there was a technical challenge of particularly reducing the number of processing steps and performing the process for as short a time as possible.

According to one embodiment of the present disclosure, the process may be simplified through the so-called in-situ process by applying a magnetic field to orient the magnetic phase powder and performing pressurization at high temperatures to perform hot compression at the same time, and the resulting deterioration of the properties of the Mn—Bi-based magnetic phase powder may be prevented.

According to one embodiment of the present disclosure, the magnetic field may be 0.1 T to 3 T, 0.1 T to 2 T, 0.1 T to 1 T, or 0.1 T to 0.5 T. When a magnetic field within the above range is applied, the Mn—Bi based magnetic phase powder may be sufficiently well oriented, and the magnetic properties of the Mn—Bi based magnet manufactured accordingly may be excellent.

According to one embodiment of the present disclosure, the hot pressing may be performed at a temperature of 100° C. to 400° C., 200° C. to 400° C., 250° C. to 350° C., or 270° C. to 310° C. by applying a pressure of 100 MPa to 400 MPa, 200 MPa to 400 MPa, 250 MPa to 350 MPa, or about 300 MPa. Through the process of performing pressurization with a pressure within the above range at a temperature within the above range, a Mn—Bi based sintered magnet may be successfully manufactured, and it may be possible to provide a sintered magnet which can prevent deterioration of the properties of the Mn—Bi based magnetic phase powder and is excellent in magnetic properties while having high density.

According to one embodiment of the present disclosure, the hot pressing may include a step of increasing pressure for 5 minutes to 50 minutes, 5 minutes to 40 minutes, 5 minutes to 30 minutes, 5 minutes to 20 minutes, 7 minutes to 20 minutes, or 10 minutes to 20 minutes so that the final pressure is 100 MPa to 400 MPa, 200 MPa to 400 MPa, 250 MPa to 350 MPa, or about 300 MPa. That is, the hot pressing may include a step of applying pressure by raising the pressure from the time point of start the application of pressure (0 MPa) until the final pressure is reached. That is, the pressure raising may be performed at a rate of 2 MPa/min to 80 MPa/min, 6 MPa to 60 MPa, or 15 MPa/min to 30 MPa/min.

When the pressure is raised at the above rate, the Mn—Bi based powder to be compressed is pressurized at a rate appropriate for molding, and the maximum magnetic energy product (BH(max)) and alignment degree (ratio of residual magnetization to saturation magnetization) are high, so a Mn—Bi based sintered magnet having excellent magnetic properties may be successfully manufactured.

In addition, the hot pressing may be performed in a vacuum atmosphere. That is, the hot pressing may further include a step of creating a vacuum atmosphere after the pressure raising step. The vacuum atmosphere may be created after the pressure reaches the final pressure by raising pressure, and a method of creating the vacuum atmosphere may adopt a method generally known in the relevant technical field. The final pressure may be continuously maintained in the vacuum atmosphere creation step.

According to one embodiment of the present disclosure, the hot pressing may further include a temperature raising step after the vacuum atmosphere creation step. The rate of temperature raising is not particularly limited, but may be about 10° C./min, and the temperature may be raised until the final temperature reaches 200° C. to 400° C., 250° C. to 350° C., or 270° C. to 310° C. The final pressure may be continuously maintained during the temperature raising step.

According to one embodiment of the present disclosure, the hot pressing may include a step of maintaining the final pressure at a temperature of 100° C. to 400° C. Specifically, it may further include a step of maintaining the final pressure at the final temperature for about 5 minutes to 15 minutes. Since the Mn—Bi based magnetic phase powder is subjected to high pressures at high temperature conditions in this step, the sintered magnet may be formed during this time.

According to one embodiment of the present disclosure, the hot pressing may further include a step of terminating temperature maintenance and performing natural cooling. The cooling may be performing cooling to a room temperature level by being left without using a separate refrigerant or coolant. The final pressure may be continuously maintained even in the cooling step.

That is, according to one embodiment of the present disclosure, the hot pressing may include: a pressure raising step; a vacuum atmosphere creation step; a temperature raising step; a final pressure and final temperature maintenance step; and a natural cooling step.

The method for manufacturing a Mn—Bi based sintered magnet according to one embodiment of the present disclosure may further include a step of heat-treating the bulk magnet cooled in this way under a magnetic field. Through such heat treatment, the squareness ratio of the sintered magnet, that is, the ratio of the residual magnetization to the saturation magnetization corresponding to the alignment degree of the anisotropic magnet increases to have the effect of improving the maximum magnetic energy product so that the magnetic properties of the Mn—Bi sintered magnet manufactured may be further improved accordingly.

According to one embodiment of the present disclosure, the heat treatment may be performed at a temperature of 100° C. to 400° C. under a magnetic field of 1 to 3 T, and it is preferable that it may be performed in a vacuum atmosphere so that oxidation of the sintered magnet is prevented at high temperatures. When heat treatment is performed under the above conditions, a sintered magnet with a higher maximum magnetic energy product value may be provided as a result by increasing the alignment degree while minimizing the decrease in saturation magnetization.

According to one embodiment of the present disclosure, a Mn—Bi based sintered magnet may be manufactured by the above method, and have a maximum magnetic energy product ((BH)ₘₐₓ) of 6 MGOe or more. Preferably, a Mn—Bi based sintered magnet having 6 MGOe to 13 MGOe may be provided.

The Mn—Bi based sintered magnet according to one embodiment of the present disclosure may be excellent in magnetic properties by having a high maximum magnetic energy product.

### Mode for Invention

Hereinafter, the present disclosure will be described in detail with reference to Examples in order to explain it specifically. However, the embodiments according to the present disclosure may be modified into various other forms, and the scope of the present disclosure is not construed as being limited to the Examples described below. The Examples of this specification are provided to more completely explain the present disclosure to those skilled in the art.

### Preparation Example 1

First, a manganese (Mn) metal powder (purchased from: iTASCO, purity: 99.95%) and a bismuth (Bi) metal powder (purchased from: Aldrich, purity: 99.999%) were mixed at a weight ratio of 56:44, and this mixed powder was charged into a furnace (manufacturer name: Indutherm, device name: Induction melter, model name: MC 20V) and then melted through an induction heating method. That is, the temperature of the furnace was instantly raised to 1200° C. to prepare a mixed melt. The mixed melt was annealed in an Ar atmosphere at a temperature of 573K for 72 hours to form a Mn—Bi based magnetic phase alloy.

The Mn—Bi based magnetic phase alloy was pulverized using a hand mill and sieved using a sieve (ASTM mesh No. 100) to obtain a Mn—Bi based magnetic phase coarse powder of 150 μm or less.

### Preparation Examples 2 to 8

The Mn—Bi magnetic phase coarse powder prepared in Preparation Example 1 was subjected to low-energy ball milling at 175 rpm for 3 hours to 21 hours to obtain a Mn—Bi based magnetic phase powder.

The ball milling times varied in Preparation Examples 2 to 8 are shown in Table 1 below.

TABLE 1

| Classification | Ball milling time (h) |
|---|---|
| Preparation Example 2 | 3 |
| Preparation Example 3 | 6 |
| Preparation Example 4 | 9 |
| Preparation Example 5 | 12 |
| Preparation Example 6 | 15 |
| Preparation Example 7 | 18 |
| Preparation Example 8 | 21 |

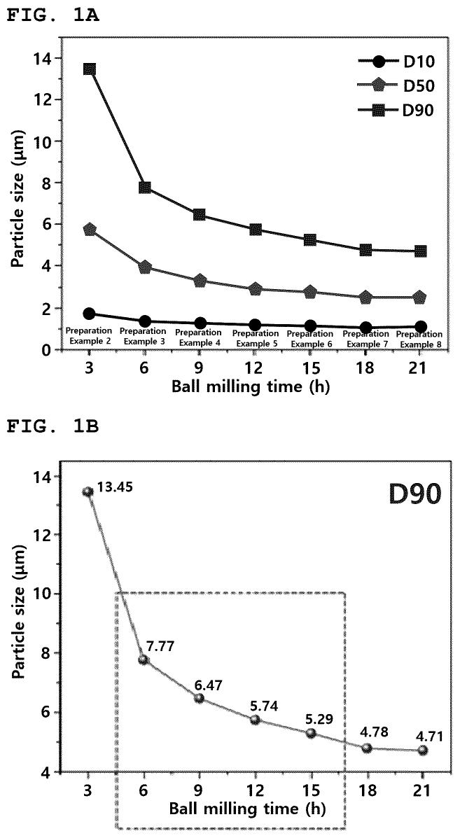

FIGS. 1a to 1d showed particle size distribution graphs of the Mn—Bi based magnetic phase powders prepared in Preparation Examples 2 to 8. Specifically, the particle sizes of the Mn—Bi based magnetic phase powders prepared in Preparation Examples 2 to 8 were analyzed using a particle size analyzer (Sympatec, Rodos T4.1 model), and D10, D50, and D90 were calculated and shown in graphs of particle size according to ball milling time in FIGS. 1a to 1d. Here, D10, D50, and D90 are average diameters (μm) of the point where the volume cumulative distribution of the powder diameter is 10%, 50%, or 90%, respectively.

Referring to FIGS. 1a to 1d, in the case of the Mn—Bi based magnetic phase powders prepared in Preparation Examples 3 to 6, the D50 value is 2.75 to 3.91 μm, the D90 value is 5.29 to 7.77 μm, and the D10 value is 1.15 to 1.35 μm, and thus it can be confirmed that the particle size distribution satisfies Equations 1 to 3 below.

$$2.5 μm \leq D 50 \leq 4. μm \qquad [ Equation 1 ]$$

$$5. μm \leq D 90 \leq 10. μm \qquad [ Equation 2 ]$$

$$1.1 μm \leq D 10 \leq 1.5 μm \qquad [ Equation 3 ]$$

### Example 1

1 g of the Mn—Bi based magnetic phase powder prepared in Preparation Example 3 was charged into a ∅10 SUS molding mold and positioned in a hot-compaction device. In the device, the applied magnetic field was set to 0.4 T, and the pressure was raised to a final pressure of 300 MPa for 10 minutes. When the pressure reached 300 MPa, it was evacuated for about 10 minutes to form a vacuum atmosphere. After the vacuum atmosphere was formed, the temperature was raised for about 30 minutes while maintaining the pressure of 300 MPa, and after reaching a final temperature of 310° C. (583K), the final temperature and final pressure were maintained for 10 minutes, and the Mn—Bi based magnetic phase powder was allowed to be naturally cooled under the pressure of 300 MPa, and when it cooled to room temperature of about 25° C., the pressure applied was removed to manufacture a Mn—Bi based sintered magnet.

### Example 2

A Mn—Bi based sintered magnet was manufactured in the same manner as in Example 1 except that the Mn—Bi based magnetic phase powder prepared in Preparation Example 4 was used.

### Example 3

A Mn—Bi based sintered magnet was manufactured in the same manner as in Example 1 except that the Mn—Bi based magnetic phase powder prepared in Preparation Example 5 was used.

### Example 4

A Mn—Bi based sintered magnet was manufactured in the same manner as in Example 1 except that the Mn—Bi based magnetic phase powder prepared in Preparation Example 6 was used.

### Example 5

A Mn—Bi based sintered magnet was manufactured in the same manner as in Example 4 except that the pressure was raised to 300 MPa for 20 seconds.

### Example 6

A Mn—Bi based sintered magnet was manufactured in the same manner as in Example 4 except that the pressure was raised to 300 MPa for 20 minutes.

### Example 7

A Mn—Bi based sintered magnet was manufactured in the same manner as in Example 4 except that the pressure was raised to 300 MPa for 60 minutes.

### Example 8

1 g of the Mn—Bi based magnetic phase powder prepared in Preparation Example 6 was charged into a ∅10 SUS molding mold and positioned in a hot-compaction device. In the device, the applied magnetic field was set to 0.4 T, and the pressure was raised to 300 MPa for 10 minutes. When the pressure reached 300 MPa, the pressure applied was removed and then evacuated for about 10 minutes to form a vacuum atmosphere. After the vacuum atmosphere was formed, the temperature was raised for about 30 minutes, and when it reached a temperature of 310° C. (583K), the temperature was maintained for 10 minutes, and then the Mn—Bi based magnetic phase powder was allowed to be naturally cooled and cooled to a room temperature level of about 25° C. to manufacture a Mn—Bi based sintered magnet.

### Example 9

The Mn—Bi based sintered magnet manufactured in Example 4 was heat-treated at a temperature of 310° C. for 30 minutes under a magnetic field of 2.5 T to manufacture a post-heat treated Mn—Bi based sintered magnet.

### Example 10

A Mn—Bi based sintered magnet was manufactured in the same manner as in Example 4 except that the final pressure was 100 MPa.

### Example 11

A Mn—Bi based sintered magnet was manufactured in the same manner as in Example 4 except that the final pressure was 200 MPa.

### Example 12

A Mn—Bi based sintered magnet was manufactured in the same manner as in Example 4 except that the final temperature was 280° C. (553K).

### Example 13

A Mn—Bi based sintered magnet was manufactured in the same manner as in Example 4 except that the final temperature was 290° C. (563K).

### Example 14

A Mn—Bi based sintered magnet was manufactured in the same manner as in Example 4 except that the final temperature was 300° C. (573K).

### Example 15

A Mn—Bi based sintered magnet was manufactured in the same manner as in Example 4 except that the final temperature was 320° C. (593K).

### Comparative Example 1

1 g of the Mn—Bi based magnetic phase powder prepared in Preparation Example 6 was added to a mold of a magnetic field molding machine. In the magnetic field molding machine, the applied magnetic field was set to 2 T, and a pressure of 100 MPa was applied to mold the powder. A Mn—Bi based sintered magnet was manufactured by applying a pressure of 100 MPa to the molded body for 10 minutes under a magnetic field of 0.4 T in hot pressing equipment.

### Comparative Example 2

A Mn—Bi based sintered magnet was manufactured in the same manner as in Example 1 except that the Mn—Bi based magnetic phase coarse powder prepared in Preparation Example 1 was used.

### Comparative Example 3

A Mn—Bi based sintered magnet was manufactured in the same manner as in Example 1 except that the Mn—Bi based magnetic phase powder prepared in Preparation Example 2 was used.

### Comparative Example 4

A Mn—Bi based sintered magnet was manufactured in the same manner as in Example 1 except that the Mn—Bi based magnetic phase powder prepared in Preparation Example 7 was used.

### Comparative Example 5

A Mn—Bi based sintered magnet was manufactured in the same manner as in Example 1 except that the Mn—Bi based magnetic phase powder prepared in Preparation Example 8 was used.

### Experimental Example 1: Evaluation of Magnetic Properties

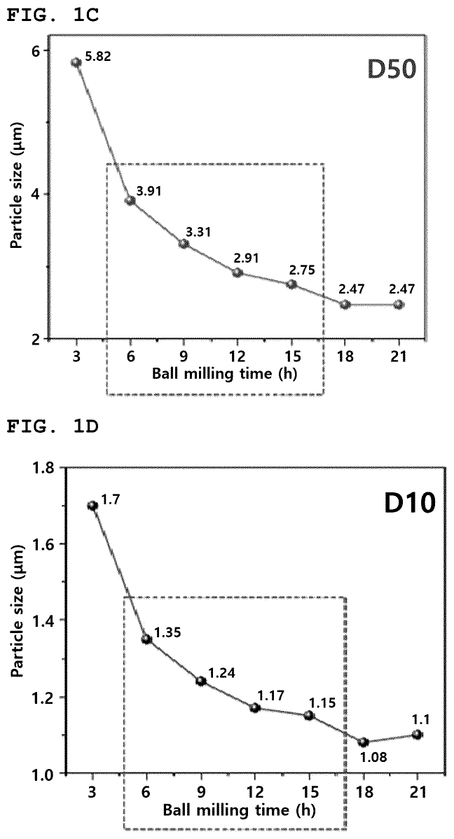

The magnetic hysteresis curves of the Mn—Bi based magnetic phase powder prepared in Preparation Example 6 above and the Mn—Bi based sintered magnets manufactured in Examples 1 to 15 and Comparative Examples 1 to 5 above were measured with Lakeshore's VSM equipment at a temperature of 300K under a magnetic field of −2.5 T to 2.5 T. The measurement results of the respective Mn—Bi based sintered magnets measured are shown in FIGS. 2 to 4.

FIG. 2 shows a graph comparing maximum magnetic energy product fractions according to ball milling time when preparing the powders of the Mn—Bi based sintered magnets manufactured in Examples 1 to 4 and Comparative Examples 2 to 5.

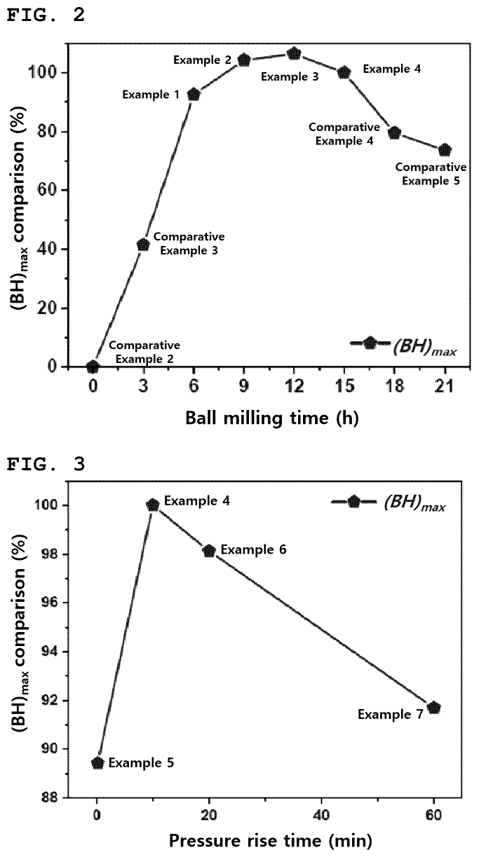

FIG. 3 shows a graph comparing maximum magnetic energy product fractions according to the pressure raising time of the Mn—Bi based sintered magnets manufactured in Examples 4 to 7.

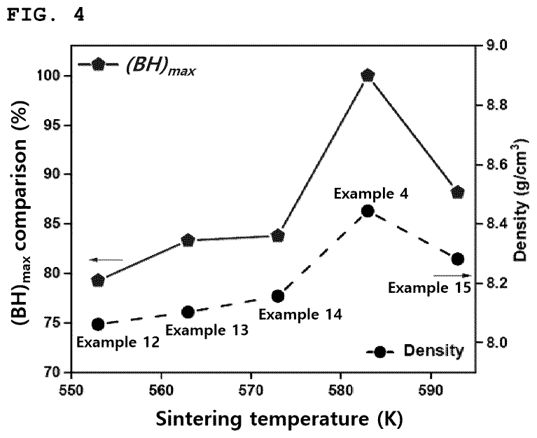

FIG. 4 shows a graph comparing densities and maximum magnetic energy product fractions according to the final temperature of the Mn—Bi based sintered magnets manufactured in Examples 4 and 12 to 15.

Density (ρ) and residual magnetization (Mr), saturation magnetization (Ms), alignment degree (Mr/Ms), coercivity (Hc), and maximum magnetic energy product ((BH)ₘₐₓ) of the Mn—Bi based magnetic phase powder prepared in Preparation Example 6, the Mn—Bi based sintered magnet manufactured in Example 4, and the Mn—Bi based sintered magnet manufactured in Example 9 were measured and shown in Table 2 below.

In addition, ratios, when the characteristics of the Mn—Bi based sintered magnet manufactured in Example 4 are set to 100%, of the density (ρ), residual magnetization (Mr), saturation magnetization (Ms), alignment degree (Mr/Ms), coercivity (Hc), and maximum magnetic energy product ((BH)ₘₐₓ) of the Mn—Bi based sintered magnets manufactured in Examples 1 to 15 and Comparative Examples 1 to 5 are expressed in % and are shown in Table 3 below.

TABLE 2

| | | | Mr/ | | | |
|---|---|---|---|---|---|---|
| | Mr | Ms | Ms*100 | Hc | ρ | (BH)max |
| | (emu/g) | (emu/g) | (%) | (Oe) | (g/cm³) | (MGOe) |
| Preparation | 65.7 | 68.9 | 95.4 | 15774 | 8.900 | 12.6 |
| Example 6 | | | | | | |
| (powder) | | | | | | |
| Example 4 | 60.01 | 67.05 | 89.50 | 8196 | 8.647 | 9.71 |
| Example 9 | 61.7 | 66.8 | 92.3 | 4500 | 8.560 | 10.5 |

TABLE 3

| | Mr | Ms | Mr/ | Hc | ρ | (BH)max |
|---|---|---|---|---|---|---|
| | (%) | (%) | Ms*100(%) | (%) | (%) | (%) |
| Example 1 | 102.0 | 104.3 | 97.8 | 87.1 | 98.6 | 92.2 |
| Example 2 | 108.3 | 108.4 | 100 | 65.6 | 98.4 | 104.7 |
| Example 3 | 106.7 | 104.3 | 102.4 | 96.9 | 98.9 | 106.2 |
| Example 4 | 100 | 100 | 100 | 100 | 100 | 100 |
| Example 5 | 98.4 | 101.2 | 97.2 | 76.8 | 100.0 | 89.3 |
| Example 6 | 97.8 | 96.0 | 101.9 | 115.9 | 99.7 | 97.3 |
| Example 7 | 93.9 | 93.3 | 100.6 | 128.0 | 101.7 | 90.7 |
| Example 8 | 91.7 | 95.4 | 96.2 | 100.7 | 100.6 | 82.2 |
| Example 9 | 61.7 | 66.8 | 92.3 | 54.9 | 99.0 | 108.1 |
| Example 10 | 101.4 | 99.5 | 101.9 | 103.3 | 94.8 | 93.6 |
| Example 11 | 100.7 | 98.6 | 102.1 | 102.8 | 96.5 | 95.3 |
| Example 12 | 91.8 | 92.7 | 99.1 | 101.3 | 1.042 | 79.3 |
| Example 13 | 93.6 | 94.7 | 98.8 | 104.2 | 96.4 | 83.3 |
| Example 14 | 95.3 | 97.8 | 97.5 | 99.1 | 97.6 | 83.8 |
| Example 15 | 97.5 | 97.8 | 99.7 | 89.6 | 98.6 | 88.2 |
| Comparative | 100.2 | 98.0 | 102.3 | 128.9 | 94.3 | 93.0 |
| Example 1 | | | | | | |
| Comparative | 19.4 | 115.2 | 16.9 | 3.2 | 101.4 | 0.03 |
| Example 2 | | | | | | |
| Comparative | 82.1 | 106.0 | 77.6 | 52.8 | 98.4 | 42.2 |
| Example 3 | | | | | | |
| Comparative | 90.1 | 92.1 | 98.0 | 125.3 | 97.5 | 79.7 |
| Example 4 | | | | | | |
| Comparative | 86.5 | 89.2 | 97.0 | 114.8 | 96.5 | 73.4 |
| Example 5 | | | | | | |

Referring to Table 3 and FIG. 2, it can be confirmed that the powders of Preparation Examples 3 to 6, which are powders for which the ball milling time is 6 to 15 hours, are excellent in magnetic properties by having high maximum magnetic energy products due to appropriate particle sizes that satisfy the Equations 1 to 3 above. In addition, it can be confirmed that the alignment degree and residual magnetization are particularly excellent. Referring to Table 3 above, it can be confirmed that the alignment degree and coercivity of Comparative Example 1, in which the magnet was manufactured (ex-situ) by separately applying a high magnetic field, must be high, but Example 4 is excellent in properties since the maximum magnetic energy product and saturation magnetization of Example 4 are higher than those of Comparative Example 1 although the sintered magnet was manufactured in Example 4 by performing pressurization (in-situ) under a lower magnetic field.

Referring to Table 3 and FIG. 3, it can be confirmed that the Mn—Bi sintered magnet of Example 4, manufactured with a pressure-raising time of 10 minutes, showed the highest maximum magnetic energy product. In addition, referring to Example 5 (a pressure-raising time of 20 seconds), Example 4 (10 minutes), Example 6 (20 minutes), and Example 7 (60 minutes), it can be confirmed that the coercivity increases as the pressure-raising time increases.

Referring to Table 3 above, it can be confirmed that the Mn—Bi based sintered magnet of Example 8 manufactured by a process without maintaining pressure has a somewhat low maximum magnetic energy product compared to the Mn—Bi based sintered magnets of Examples 4 and 5 manufactured by a process maintaining pressure.

Referring to Table 2 above, it can be confirmed that the magnetic properties of the powder itself are somewhat deteriorated when it is prepared with a Mn—Bi based sintered magnet, and it can be confirmed that, when additional heat treatment is performed, the magnetic properties that had been deteriorated are partially recovered again.

Referring to Table 3, when the final pressure of the process increases, the distance between magnetic particles decreases accordingly, and when the distance between magnetic particles decreases to the critical distance or less, antiferromagnetism is formed due to the formation of a local magnetic field, which leads to a decrease in alignment degree. Therefore, referring to Example 10 (a final pressure of 100 MPa), Example 11 (200 MPa), and Example 4 (300 MPa), it can be confirmed that the residual magnetization, alignment degree, and coercivity tend to decrease as the pressure increases.

Meanwhile, since the density of the magnet manufactured also increases proportionally when the pressure increases, it can be confirmed that Example 4, which has the highest final pressure, has the highest density and also has the largest maximum magnetic energy product.

Referring to Table 3 and FIG. 4, it can be confirmed that the sintered magnet of Example 4, where the final temperature was set to 310° C., had the highest density and maximum magnetic energy product so that it was excellent in magnetic properties.

### Experimental Example 2: Evaluation of Maintenance of High Temperature Properties

The magnetic hysteresis curve of the Mn—Bi based sintered magnet manufactured in Example 9 above was measured using Lakeshore's VSM equipment at a temperature of 350K, 400K, 450K, or 600K under a magnetic field of 2.5 T. The residual magnetization (Mr), saturation magnetization (Ms), alignment degree (Mr/Ms), coercivity (Hc), and maximum magnetic energy product ((BH)ₘₐₓ) at various temperature conditions of the Mn—Bi based sintered magnet manufactured in Example 6 were measured through each measured magnetic hysteresis curve of the Mn—Bi based sintered magnet and are shown in Table 4 below.

TABLE 4

| Example 9 | | | | | | |
|---|---|---|---|---|---|---|
| Measurement | Mr | Ms | Mr/ | | | |
| environment | (emu/ | (emu/ | Ms*100 | Hc | ρ | (BH)max |
| temperature | g) | g) | (%) | (Oe) | (g/cm³) | (MGOe) |
| 300 K | 61.7 | 66.8 | 92.3 | 4500 | 8.560 | 10.5 |
| 350 K | 57.61 | 61.93 | 93.0 | 8479 | 8.560 | 9.2 |
| 400 K | 54.57 | 58.22 | 93.7 | 13888 | 8.560 | 8.3 |
| 450 K | 51.02 | 54.20 | 94.1 | 19345 | 8.560 | 7.3 |
| 600 K | 30.54 | 34.00 | 89.8 | 22874 | 8.560 | 2.6 |

Referring to Table 4, it can be confirmed that the Mn—Bi based sintered magnet manufactured by performing post-heat treatment maintains its magnetic properties even at high temperatures.

Although the present disclosure has been described above with limited Examples, the present disclosure is not limited thereto, and it goes without saying that various modifications and variations can be made by those skilled in the art to which the present disclosure pertains within the equivalent scope of the technical idea of the present disclosure and the claims to be described below.

1. A method for manufacturing a Mn—Bi based sintered magnet, comprising steps of:
preparing a Mn—Bi based magnetic phase powder; and
hot-pressing the magnetic phase powder under a magnetic field to manufacture it into a bulk magnet,
wherein the magnetic phase powder has a particle size distribution that satisfies the following Equation 1:
2.5 μm≤D50≤4.0 μm [Equation 1]
D50 is an average diameter (μm) of the point where the volume cumulative distribution of the diameter of the magnetic phase powder is 50%.

2. The method of claim 1, wherein the step of preparing a Mn—Bi based magnetic phase powder comprises steps of:
manufacturing a Mn—Bi based magnetic phase alloy;
pulverizing the Mn—Bi based magnetic phase alloy to prepare a Mn—Bi based magnetic phase coarse powder; and
micronizing the Mn—Bi based magnetic phase coarse powder to prepare a Mn—Bi based magnetic phase powder.

3. The method of claim 2, wherein the Mn—Bi based magnetic phase alloy has a composition of MnₓBi_{1-x-y}A_{y}, where A is one or more selected from Sn, Mg, Sb, C, and N, x is 0.4 to 0.6, and y is 0 to 0.1.

4. The method of claim 2, wherein the step of micronizing the coarse powder is performed by ball milling the Mn—Bi based magnetic phase coarse powder for 3 to 21 hours.

5. The method of claim 1, wherein the magnetic field is 0.1 T to 3 T.

6. The method of claim 1, wherein the hot pressing is performed at a temperature of 100° C. to 400° C. by applying a pressure of 100 MPa to 400 MPa.

7. The method of claim 6, wherein the hot pressing comprises a step of increasing pressure for 5 minutes to 50 minutes so that the final pressure is 100 MPa to 400 MPa.

8. The method of claim 7, wherein the hot pressing comprises a step of maintaining the final pressure at a temperature of 100° C. to 400° C.

9. The method of claim 1, further comprising a step of heat-treating the bulk magnet under a magnetic field.

10. The method of claim 9, wherein the heat treatment is performed at a temperature of 100° C. to 400° C. under a magnetic field of 1 to 3 T.

11. A Mn—Bi based sintered magnet which is manufactured by the method according to claim 1, and has a maximum magnetic energy product ((BH)ₘₐₓ) of 6 MGOe or more.
